(19) United States
(12) Patent Application Publication
(10) Pub. No.: US 2022/0026183 A1
(43) Pub. Date: Jan. 27, 2022

(54) Durable Articulated Joints and Mannequins Made Therewith

(71) Applicant: NOA Brands America, Inc., Lafayette, CO (US)

(72) Inventors: Scott AMMAN, Thornton, CO (US); Peter FITZSIMMONS, Frederick, CO (US)

(73) Assignee: NOA Brands America, Inc., Lafayette, CO (US)

(21) Appl. No.: 17/383,614

(22) Filed: Jul. 23, 2021

Related U.S. Application Data
(60) Provisional application No. 63/056,020, filed on Jul. 24, 2020.

(51) Int. Cl. F41J 1/00; A47F 8/02; F16C 11/04

(52) U.S. Cl. CPC F41J 1/00; F16C 11/04; A47F 8/02

(57) ABSTRACT

Embodiments of the disclosure include mannequins and parts thereof. The disclosure includes descriptions of articulated joints for mannequins, specifically, for positioning and posing mannequins in one or more positions. The disclosure also includes descriptions of retail mannequins and target or tactical mannequins incorporating one or more articulated joints. In the case of a tactical mannequin, a tactical mannequin incorporating one or more articulated joints may have advantages in being able to withstand (e.g., maintain structural and mechanical integrity) under extreme conditions, all the while being cost-effective and being able to be easily re-positioned. Retail mannequins incorporating one or more articulated joints may weigh less than conventional mannequins while being easily repositionable and durable. Another aspect of the present disclosure describes methods of manufacturing mannequins incorporating one or more articulated joints, such as, for example, in a cold rotational molding process.

### CROSS-REFERENCE TO RELATED APPLICATIONS

The present application claims priority to U.S. Provisional Patent Application Ser. No. 63/056,020 filed on Jul. 24, 2020, the entirety of which is hereby incorporated by reference.

### TECHNICAL FIELD

The present disclosure relates to mannequins. More specifically, aspects of the present disclosure relate to mannequin joints as well as distinct applications of mannequin joints on mannequins, such as retail mannequins and tactical or target mannequins capable of withstanding training and less-than-lethal ammunition. Mannequin joints according to one or more aspects of the present disclosure may present advantages in positioning and durability.

### BACKGROUND

Conventional mannequins, such as those used in retail settings, often prioritize weight minimization and convenience, as they are typically stationary and serve as a display for clothing. Often, retail stores prioritize a lightweight mannequin, as such mannequins may be more maneuverable for a typical retail employee. Retail stores have often prioritized mannequins that are easier to dress and undress, such as mannequins having a stretch shoulder joint moving an arm from a lateral to a medial position to don a shirt or a stretch hip joint moving a leg from a lateral to a medial position to remove slacks. Stretch joints, and other types of joints having similar purposes, may have complex constructions and numerous parts, adding cost, weight, and complexity to the mannequin.

Moreover, joints having advantages in retail mannequins, such as stretch joints, may be less effective outside of the retail setting. For example, to a mannequin being used as a target for live or non-lethal ammunition, temporarily moving an arm or a leg medially or laterally presents no advantage, metal components may increase the risk of ricochet, and complex joints could yield a costly or complex repair.

In both retail and target settings, having an adjustably poseable mannequin would present advantages. A simpler and more lightweight joint could reduce weight and joint complexity. And a joint that could be effectively and reliably implemented on mannequins in both retail and target or tactical settings would present manufacturing advantages. The present disclosure may address the foregoing aspects and others.

### SUMMARY OF THE DISCLOSURE

One aspect of the present disclosure describes articulated joints for mannequins, specifically, for positioning and posing mannequins in one or more positions. Embodiments of the disclosure may include articulated shoulder, elbow, hip, or knee joints.

Another aspect of the present disclosure describes mannequins incorporating one or more articulated joints. In one embodiment, a retail mannequin may include one or more articulated shoulder, elbow, hip, or knee joint. In another embodiment, a target or tactical mannequin may include one or more articulated shoulder, elbow, hip, or knee joints.

Another aspect of the present disclosure describes methods of manufacturing mannequins incorporating one or more articulated joints, such as, for example, in a cold rotational molding process.

In an embodiment, a joint system may include a first component having an external surface and a hollow second component having an internal surface, wherein the first component and the second component may be sized to couple with each other by an interference fit such that, when the first component and the second component are coupled, at least a portion of the external surface of the first component maintains contact with at least a portion of the internal surface of the second component, and wherein the first component may be configured to be disposed in a first mannequin part and the second component may be configured to be disposed in a second mannequin part. The first component and the second component may comprise acrylonitrile butadiene styrene.

In another embodiment, a joint system may include a first component having an external surface and a hollow second component having an internal surface, wherein the first component and the second component may be sized to couple with each other by a snap fit or snap-lock fit such that, when the first component and the second component are coupled, at least a portion of the external surface of the first component fits at least partially within at least a portion of the interior of the second component, and wherein the first component may be configured to be disposed in a first mannequin part and the second component may be configured to be disposed in a second mannequin part. The first component may include ridges, notches, or grooves configured to engage complementary ridges, notches, or grooves on the second component to attain a snap-lock fit. The first component and the second component may comprise acrylonitrile butadiene styrene.

In another embodiment, a figure shaped as a human or a portion of a human may include a first hollow shell sized and shaped like a first human part and comprising a thermosetting polymer, a second hollow shell sized and shaped like a second human part and comprising a thermosetting polymer, a first joint component having an external surface and being disposed in the first hollow shell, and a hollow second joint component having an internal surface and disposed in the second hollow shell. The first joint component and the second joint component may be sized to couple with each other by an interference fit such that, when the first joint component and the second joint component are coupled, at least a portion of the external surface of the first joint component maintains contact with at least a portion of the internal surface of the second joint component. Alternatively or additionally, the first component may include ridges, notches, or grooves configured to engage complementary ridges, notches, or grooves on the second component to attain a snap-lock fit. The first joint component and the second joint component may comprise acrylonitrile butadiene styrene.

In another embodiment, a method of manufacturing a mannequin part may include calculating a total amount of a polyurethane by weight to be added to a mannequin mold, disposing a substantially cylindrical and hollow acrylonitrile butadiene styrene joint component in the mannequin mold, adding a first shot of between about 40% to about 50% of the calculated total amount of the polyurethane to the mold, rotating the mold in a first rotating step at a temperature of between about 100 degrees Fahrenheit to about 120 degrees Fahrenheit, adding a second shot comprising the reminder of the calculated total amount of polyurethane to the mold; rotating the mold in a second rotating step at a temperature of between about 100 degrees Fahrenheit to about 120 degrees Fahrenheit; and removing the molded polyurethane from the mold.

### BRIEF DESCRIPTION OF THE DRAWINGS

The foregoing and other features of the present disclosure may become more fully apparent from the following description, taken in conjunction with the accompanying drawings. Understanding that these drawings depict only several embodiments in according with the disclosure and are, therefore, not to be considered limiting of its scope, the disclosure will be described with additional specificity and detail through use of, and example reference to, the drawings. In the drawings:

FIG. 1 depicts example mating joint components according to an aspect of the present disclosure.

FIG. 2 depicts an example of mating joint components that have been coupled with an interference fit according to an aspect of the present disclosure.

FIG. 3 depicts another example of mating joint components that have been coupled with an interference fit according to an aspect of the present disclosure.

FIG. 4 illustrates an example of mating joint components, each partially coated with polyurethane, coupled with an interference fit according to an aspect of the present disclosure.

FIG. 5 depicts an example of mating joint components according to another aspect of the present disclosure.

FIG. 6 shows an example mannequin having a plurality of components coupled to each other via articulated joints according to one or more aspects of the present disclosure.

FIG. 7 shows a top view of an example female mating joint component configured to couple with a corresponding male joint component for a snap fit.

FIG. 8 shows an isometric view of exterior surfaces of an example female mating joint component configured to couple with a corresponding male joint component for a snap fit.

FIG. 9 shows a sectional view of an example female mating joint component configured to couple with a corresponding male joint component for a snap fit.

FIG. 10 shows an isometric view of interior surfaces of an example female mating joint component configured to couple with a corresponding male joint component for a snap fit.

FIG. 11 shows a top view of an example male mating joint component configured to couple with a corresponding female joint component for a snap fit.

FIG. 12 shows a side perspective view of an example male mating joint component configured to couple with a corresponding female joint component for a snap fit.

FIG. 13 shows an enlarged portion of the side perspective view of the example male mating joint component configured to couple with a corresponding female joint component for a snap fit depicted in FIG. 12.

### DETAILED DESCRIPTION OF THE DISCLOSURE

In the following detailed description, reference is made to the accompanying drawings, which form a part of the description. In the drawings, similar symbols identify similar components, unless the context dictates otherwise. The illustrative embodiments described in the detailed description and drawings are not meant to be limiting. Other embodiments may be utilized, and other changes may be made, without departing from the spirit or scope of the subject matter presented herein. It will be readily understood that aspects of the present disclosure, as described herein and illustrated in the drawings, may be arranged, substituted, combined, and designed in a wide variety of different configurations, all of which are explicitly contemplated and make part of this disclosure.

This disclosure is generally directed to mannequins and parts thereof. One aspect of the present disclosure describes articulated joints for mannequins, specifically, for positioning and posing mannequins in one or more positions. Embodiments of the disclosure may include articulated shoulder, elbow, hip, or knee joints. Another aspect of the present disclosure describes mannequins incorporating one or more articulated joints. In one embodiment, a retail mannequin may include one or more articulated shoulder, elbow, hip, or knee joints. In another embodiment, a tactical mannequin (e.g., a mannequin used as a target for live or non-lethal ammunition or to simulate a human in a tactical situation such as a rescue mission) may include one or more articulated shoulder, elbow, hip, or knee joints. In the case of a tactical mannequin, a tactical mannequin incorporating one or more articulated joints may have advantages in being able to withstand (e.g., maintain structural and mechanical integrity) under extreme conditions, all the while being cost-effective and being able to be easily re-positioned. Another aspect of the present disclosure describes methods of manufacturing mannequins incorporating one or more articulated joints, such as, for example, in a cold rotational molding process.

As used herein, a “male” component, with respect to a component in a press-fit or friction-fit connection, refers to the component having a relatively smaller diameter than its mating component. A “female” component, with respect to a component in a press-fit or friction-fit connection, refers to the component having a relatively larger diameter than its mating component. A male component may have an external diameter slightly less than, but approximately equal to, the inner diameter of a female component. With respect to a snap-fit connection or coupling, a male component refers to the component configured to be inserted at least partially into a corresponding female component. Male and female components configured for use in a snap-fit coupling may include cooperating ridges, notches, or grooves such that ridges, notches, or grooves on one component may engage corresponding features on the other component, such that the components remain coupled in typical use but may be decoupled with effort from a user. The force required to remove one snap-fit component from the other may vary with application (e.g., less force in a retail application or more force in a tactical application).

A mannequin joint may comprise a plurality of joint components and may connect one mannequin component to another mannequin component. For example, a shoulder joint may connect a mannequin arm to a mannequin torso, and a hip joint may connect a mannequin leg to a mannequin torso. Similarly, an elbow joint may connect a mannequin forearm to a mannequin upper arm, and a knee joint may connect a mannequin shin to a mannequin thigh. Mannequins according to the present disclosure may have one or more joints. Still further, a neck joint may connect a mannequin head to a mannequin torso. Generally, more joints may enable the mannequin to be positioned in a larger variety of positions, though in some scenarios a mannequin with fewer joints may be desired.

A mannequin joint may comprise a plurality of joint components, with at least a first joint component on one mannequin part (e.g., in an embodiment, the one mannequin part may be a torso) and a second joint component on another mannequin part (e.g., in an embodiment, the other mannequin part may be an arm or a leg or a head). The plurality of joint components may be coupled to form a joint. When joint components are coupled to form a joint, the joint and the mannequin parts connected by the joint may be alternatively positioned. In an embodiment, a joint may be formed from two joint components, wherein each of the two joint components may be disposed in a respective mannequin part. A person of skill in the art may appreciate that the joint components may be coupled in a wide variety of ways, and mannequin parts can be attached to form a mannequin in a variety of positions.

In an embodiment, the joint components may be coupled to each other by an interference fit (e.g., a press fit or a friction fit). As used herein, the term “interference fit” encompasses couplings made by mating components being pushed together, the coupling being maintained by friction after the mating components are pushed together and coupled, and not the degree or tightness of the fit. A person of skill in the art will appreciate that the tightness of an interference fit can be designed or configured based on the intended application. With respect to the present disclosure, joint components for a tactical mannequin may be configured to form a tighter interference fit (e.g., to maintain a mannequin's position after being shot) than joint components for a retail mannequin (e.g., to allow a typical retail employee to reposition a mannequin). In an embodiment, joint components may be substantially cylindrical with one joint component, e.g., a male joint component, having an external diameter close to, but slightly smaller than, the inner diameter of the other joint component, e.g., a female joint component, such that the male joint component may fit inside the female joint component, and the joint components may experience frictional forces maintaining the joint components in place. Cylindrical components may enable a larger range of positions, though the joint components may comprise alternative shapes (with a potential tradeoff being a reduced range of positions but perhaps a more secure fit). In an embodiment, joint components may be cylindrical with the male component having a plurality of ridges on its external diameter of its mating face, and the female component may have a plurality of ridges on its internal diameter of its mating face such that the two sets of ridges may cooperate to create a more secure fit rotationally but may still allow a large number of mannequin positions to be easily created when desired by a user (e.g., a retail worker or a target range officer).

In an embodiment, the joint components may be coupled together by a snap-fit coupling. Male and female components configured for use in a snap-fit coupling may include cooperating ridges, notches, or grooves such that ridges, notches, or grooves on one component may engage corresponding features on the other component, such that the components remain coupled in typical use but may be decoupled with effort from a user. To engage a snap-fit coupling, a user may insert a male joint component at least partially into the female joint component such that ridges, notches, or grooves on the male component engage corresponding ridges, notches, or grooves on the female component. The force required to remove one snap-fit component from the other may vary with application (e.g., less force in a retail application or more force in a tactical application).

In an embodiment, mating joint components according to aspects of the present disclosure may comprise or be constructed of one or more thermoplastic polymers. In a particular embodiment, mating joint components may be constructed from acrylonitrile butadiene styrene or ABS.

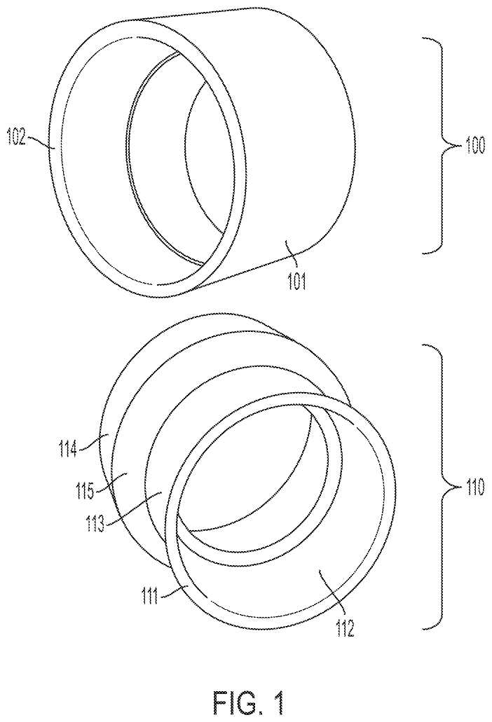

FIG. 1 depicts example mating joint components according to an aspect of the present disclosure. Mating joint components 100, 110 may, when coupled, form a joint. Male joint component 100 may be substantially cylindrical, having a substantially circular cross section 102. Male joint component 100 may include an external face 101 having a diameter slightly smaller than the inner diameter of an inner face 112 of a female joint component 110. Female joint component 110 may be substantially cylindrical and have a substantially circular cross section 111. In an embodiment, female joint component 110 may be substantially cylindrical but have two or more sections, each section having a circular cross section with a different diameter. In an embodiment, female joint component 110 may have a first section 114 with a cross-sectional diameter larger than a cross-sectional diameter of a second section 113. A male joint component could also have a similar configuration if desired, but different configurations are shown here to illustrate breadth. In the embodiment of FIG. 1, the diameter of the outer face 101 of the male joint component 100 is close to, but slightly smaller than, the diameter of the inner face 112 of the female joint component 110 so that, when male joint component 100 is pressed into female joint component 110 (in this embodiment, through at least a portion of section 113), an interference-fit coupling results, with the joint being maintained in the configuration through friction between the outer face 101 of the male component 100 and the inner face 112 of the female component 110.

In an embodiment, the tightness of an interference fit may be altered by changing the external diameter of male joint component 100, the internal diameter of female joint component 110, the materials from which male joint component 100 and female joint component 110 are constructed, the smoothness or roughness of the external diameter of male joint component 100, the smoothness or roughness of the internal diameter of female joint component 110, and the like.

In an embodiment, male component 100 and female component 110 may be coupled with by a snap fit.

In the embodiment of the female joint component 110 in FIG. 1, as explained above, a first section 114 and a second section 113 have different cross-sectional diameters. When incorporated into a mannequin component, first section 114 may be disposed within the mannequin part and may help to resist the joint component from being pulled out of the mannequin part. Specifically, material forming a mannequin component may be formed around the first section 114, a tapered flange portion 115, and possibly over second section 113 or a portion thereof. In such a configuration, material forming the mannequin component may withstand pulling forces, such as when mated joint components 100, 110 are pulled apart to reposition a mannequin. In an embodiment, male joint component 100 may have sections having different cross sectional diameters with a tapered flange portion between the two.

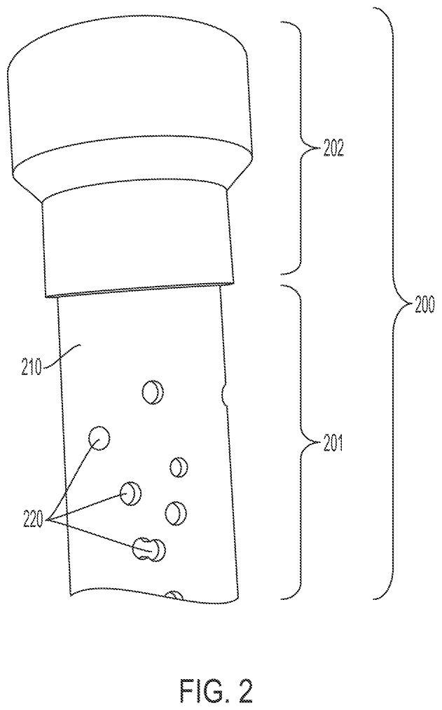

FIG. 2 depicts an example of mating joint components that have been coupled with an interference fit according to an aspect of the present disclosure. Coupled mating joint components 200 may form a joint that may be used to couple mannequin components. Mating joint components 201, 202 may couple together with an interference fit. An outer face 210 of a male joint component 201 may engage with an inner face of a female joint component 202 via frictional forces. Alternatively or additionally, mating joint components 201, 202 may couple together with a snap fit.

Mating joint components according to one or more aspects of the present disclosure may be constructed from ABS. ABS, as a relatively cheap and abundant thermoplastic material, along with the simplicity of the design of the mating joint components, may render a mannequin joint that can be used in a plurality of applications. A lightweight and highly functional joint may be employed in a retail setting. Additionally, mating joint components constructed from ABS may present advantages in toughness and durability in tactical mannequins. In FIG. 2, male joint component 201 has been subjected to impacts with live ammunition, resulting in bullet holes 220. Male joint component 201 was able to withstand the live ammunition, resulting in bullet holes 220 but no cracks or other macro-scale damage was sustained. The coupled mating joint components 200 maintained the coupled arrangement even after being subjected to live fire. Advantageously and surprisingly, tactical mannequins constructed with joint components according to aspects of the present disclosure may be able to better withstand repeated impacts from live or less-than-lethal ammunition due to the lack of cracking or macro-scale damage while retaining functionality (such as the integrity of the joint and security of the coupling) and the ability to be repositioned. Other joint designs, including more complex joint designs or designs constructed from metal or more brittle plastics may fail more readily or may cause dangerous ricochet, particularly in a tactical environment where a joint component may be subject to live ammunition.

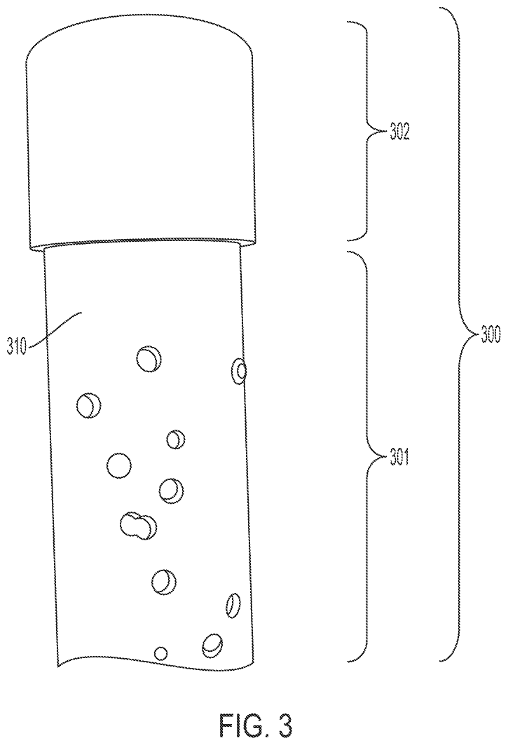

FIG. 3 depicts another example of mating joint components that have been coupled with an interference fit according to an aspect of the present disclosure. Coupled mating joint components 300 may form a joint that may be used to couple mannequin components. Mating joint components 301, 302 may couple together with an interference fit. In an alternative embodiment, mating joint components 301, 302 may couple together with a cooperative, threaded coupling. In an interference fit embodiment, an outer face 310 of a male joint component 301 may engage with an inner face of a female joint component 302 via frictional forces. In the embodiment depicted in FIG. 3, female joint component 302 is substantially cylindrical and has a consistent circular cross-sectional diameter across the component. Like the coupled mating joint components 200 of FIG. 2, the coupled mating joint components 300 may be able to withstand impacts from live ammunition without macro-scale failure. In a retail application, coupled mating joint components 300 may be able to withstand impacts from a mannequin falling, an employee dropping a mannequin part, or the like without failure. The simplicity of joint components made, for example, from a thermoplastic like ABS (or a thermoplastic with similar physical properties) that couple with an interference fit or by a simple threaded coupling may advantageously provide benefits not only in the ease of use (allowing entry-level employees to manipulate a mannequin without substantial training or knowledge) but also in durability (as there are less parts that can break, the joint component material can withstand impacts, and there are less small or sensitive parts susceptible to breakage).

Mating joint components may be disposed in mannequin components. In an embodiment, when a mannequin component (e.g., torso, arm, leg, head) is being formed or manufactured, one or more mating joint components may be disposed therein such that the mannequin component have one or more mating joint components formed therein. In an embodiment, a mannequin component may be manufactured in a cold rotational molding process, with the mating joint component(s) being disposed within a designated portion of the tool, then dispensing a mannequin material (e.g., polyurethane) into the tool and rotationally molding the mannequin component.

In an embodiment, for example an embodiment where a tactical mannequin is being manufactured, a mannequin component may be formed through a cold rotational molding process. In an embodiment, an outer shell of a mannequin component may comprise one or more polyurethanes. In an embodiment, a cold rotational molding process may involve disposing a mating joint component in a mold, coating the mold in polyurethane resin, then, before the resin completely sets and cures (e.g., while the resin has formed its shape but is still tacky), a second addition of polyurethane resin may be added to the mold. The polyurethane in the second addition may comprise the same or different ingredients as the first addition of polyurethane. In an embodiment, both the first and second additions of polyurethane may form a hard shell. In an embodiment, when the first and second additions of polyurethane have set, a mannequin shell having a thick outer shell may be formed. Such a thicker outer shell may make such a mannequin more puncture resistant, particularly against simulation or trainer ammunition and non-lethal ammunition. Additionally or alternatively, a mannequin formed in such a manner may be resistant to deformation at elevated temperatures, which may be significant if, for example, a mannequin is positioned to simulate a fire victim in a search and rescue exercise.

In an embodiment, a mannequin, or a part thereof, may be produced according to the following process. The mannequin or mannequin parts may be made in a two-stage cold rotational molding process using two additions (also called “shots”) of polyurethane. In an embodiment, the polyurethane may be the same polyurethane in both shots. Alternatively, the polyurethane in the second shot may be different than the polyurethane in the first shot (e.g., may be configured to foam). First, the total amount of polyurethane may be calculated (e.g., by volume of liquid material, by weight, etc.). The amount required may vary depending on the size of the mannequin or mannequin part and desired finished thickness. Second, the total amount of material may be divided into the two shots. In an embodiment, the first shot may comprise about 45% by weight of the total amount of polyurethane, with the remaining about 55% in the second shot. While the amount of material in each respective shot may be varied, as would be understood by a person of ordinary skill in the art, having too much material in the first shot may cause blockages in the mold and may prevent even coverage of the mold by the first shot. In another embodiment, the first shot may comprise about 40% by weight of the total calculated amount of polyurethane, and the second shot may include about 60% by weight of the total calculated amount of polyurethane. In another embodiment, the two shots may be evenly split. In another embodiment, material may be added in more than two shots, which may enable still a thicker shell while assuring even coating of the mold and preventing blockages.

In an embodiment, after the material is divided into shots, the first shot may be added to the mold. Next, a specific pre-rotation process may be executed, ensuring that the polyurethane of the first shot covers the entire mold before setting. In an embodiment, the pre-rotation process may last about 30 seconds. Then, the mold may rotate for about five and a half more minutes. Then, the second shot of polyurethane may be added. The material added in the first shot may have set but may still be not completely cured. In such a state, the material of the first shot may still be tacky, ensuring good adhesion of the material of the second shot to the material of the first shot and making separation between the material of the first and second shots unlikely. After the second shot is added, a pre-rotation process may be executed to assure even coating of the second shot. After the pre-rotation process (e.g., about thirty more seconds), the tool may be rocked and rolled in a rotation process. In an embodiment, this rotation process may continue for about another 33.5 minutes, yielding a total of about 40 minutes from the time the first shot was added, before demolding.

In an embodiment, both the first shot and the second shot of polyurethane may be the same material. In an embodiment, the polyurethane may comprise a ratio of between about 70:100 isocyanate:polyol to about 100:82 isocyanate:polyol by volume of the components. In an alternate embodiment, the polyurethane may comprise a ratio of about 801:1000 isocyanate:polyol by volume of the components.

In an embodiment, mannequins made according to one or more aspects of the present disclosure may be more resistant to deformation under temperatures up to 170, or 180 or 185° F. There is no need for a metal armature inside the mannequin to provide support for the outer walls. The molded articles may be made by a process of cold rotational molding (rather than a melted thermoplastic or thermosetting rotational molding process), at or around room temperature.

The method may performed at a temperature within the mold sufficient to maintain the first and second polymer mix at viscosities low enough to form and set into coatings, but not too low to prevent the mix from flowing well enough to coat the inner surface of the mold. Typically this temperature will be between about 105 and about 115° F.

In an embodiment, the uncured polymer mixes comprise polyurethane, which may have as components polyol or polyester resin, isocyanate, and a curing catalyst. The uncured polymer mixes can also comprise pigments or dyes effective to produce a desired color for the shell. In embodiments, the first mix, for the polymer shell, has an isocyanate to polyol ratio of about 77:100. In an alternate embodiment, the polymer shell (including either one or both of the first shell and/or the second shell) includes an isocyanate to polyol ration of about 801:1000 by volume of the components. In an embodiment, a mannequin may further include a foam backing manufactured as a third shot, and the foam backing, may have an isocyanate to polyol ratio of about 100:82 to about 100:92, and in a specific embodiment, 100:87 by volume of the components. The isocyanate to polyol ratio is selected so as to provide a reaction that produces a desirable flow time as further described below. The slower the reaction, the longer the period during which the mix will stay liquid enough to flow. The isocyanate to polyol ratio, along with the polymer components and other system parameters are selected so as to produce the desired amount of foam and/or shell in the desired amount of time.

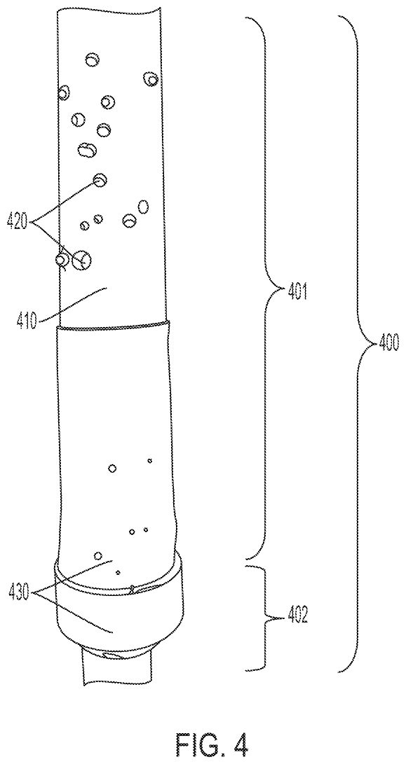

FIG. 4 illustrates an example of mating joint components, each partially coated with polyurethane, coupled with an interference fit according to an aspect of the present disclosure. Coupled mating joint components 400 may couple by an interference fit between an outer face 410 of a male joint component 401 and an inner face of a female joint component 402. Mating joint components 401, 402 may be coated in a polyurethane 430, and the polyurethane 430 may remain disposed on mating joint components 401, 402. In an embodiment, mating joint components 401, 402 may be formed from ABS. In use on a tactical mannequin, for example, coupled mating joint components 400 may be able to withstand fire from live ammunition while sustaining only local damage (e.g., bullet holes 420) and resisting macro-scale damage (e.g., large cracks) or failure of the component. In an embodiment, when subjected to live ammunition, coupled mating joint components 400 may remain substantially coated in polyurethane 430. Portions of mating joint components to be coated in a material such as polyurethane may be finished or manufactured to have rough surfaces, which may promote better adhesion of the coating. Accordingly, mating joint components of the present disclosure may have advantages in remaining securely disposed within a mannequin part, whereas more conventional joint components may, over time, become loose or less secure (e.g., through transmission of shock from repeated, intense impacts).

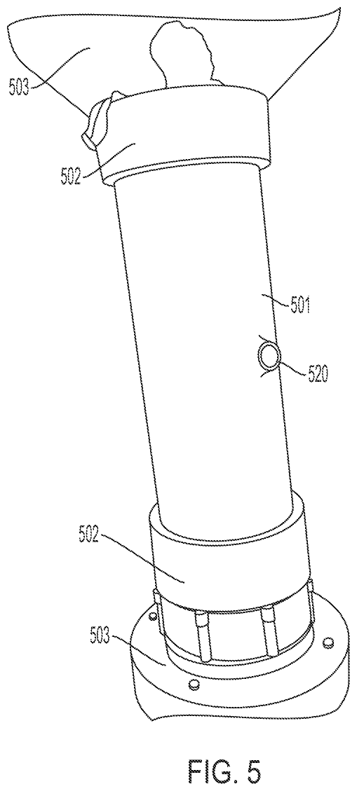

FIG. 5 depicts an example of mating joint components according to another aspect of the present disclosure. As shown in FIG. 5, mannequin components may be integrally formed with one or more joint components. In other embodiments and depictions, one mannequin component may have a male joint components, and that mannequin component may couple with a mannequin component having a complementary female joint component, wherein the male joint component and the female joint component couple via an interference fit, yielding a mannequin having a joint that can articulate, allowing the mannequin to be positioned and repositioned. In an alternate embodiment, mannequin components 503 may each have a female joint component 502. Additionally or alternatively, joint components may couple with each other by a snap fit. A male joint connector 501 may be introduced to couple the female joint components 502. Joint components 501, 502 may be constructed from ABS and may be able to withstand fire from live ammunition with minimal damage (e.g., bullet hole 520) without component or joint failure.

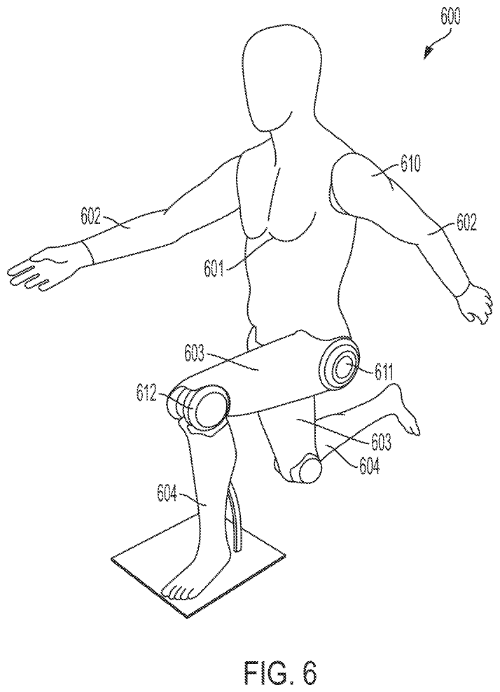

FIG. 6 shows an example mannequin having a plurality of components coupled to each other via articulated joints according to one or more aspects of the present disclosure. Mannequin 600 having a plurality of articulated joints may comprise a torso 601, arms 602, thighs 603, and shins 604. Articulated joints (in mannequin 600, shoulders 610, hips 611, and knees 612) may be formed from male joint components and female joint components that have been coupled by interference fits, as has been described in this disclosure. Additionally or alternatively, articulated joints may be formed from male joint components and female joint components that have been coupled by a snap fit. As an example, torso 601 may comprise a plurality of female joint components, one in each shoulder and hip. Each arm 602 may comprise a male joint component in the shoulder area to couple to the corresponding female joint component on the torso 601 by interference fit or snap fit. Thighs 603 may each have a male joint component in the hip area to mate with a corresponding female joint component in the torso 601 by interference fit or snap fit. Thighs 603 may also each have a female joint component in the knee area to mate with a corresponding male joint component in shin 604 by interference fit or snap fit. Such a configuration of mannequin components and joint components may allow each joint to be articulated to position a mannequin 600 into a large number of varying positions. Possible positions of mannequin 600 include standing, sitting, kneeling, walking, running, and variations of the same. A torso and head may also include mating joint components interfacing at the neck area of a mannequin, allowing for replaceable and poseable head positions.

In an additional or alternative embodiment, a torso may include one or more sensors configured to detect the impact of a projectile (e.g., bullet, less-than-lethal ammunition, simunition, etc.) on a mannequin or mannequin part. The one or more sensors may include a microphone, an acoustic location sensor, a pressure sensor, a positional sensor, a heat sensor or thermometer, a current sensor (and any corresponding components needed to detect changes in a current), a metal detector, motion sensor, gyroscope, a flex sensor, impact sensor, shock detector, a piezoelectric sensor, tactile sensor, force gauge, or the like. In an embodiment, one or more joint components may each have one or more sensors configured to detect the impact of a projectile. By including such a sensor in a mannequin, for example, whether a mannequin is impacted (e.g., hit or miss) and/or in what location a mannequin is impacted (e.g., center mass, side torso, leg, arm, head, etc.) may be determined, and corresponding feedback may be generated and transmitted to a user. Such a system may be useful for training purposes, for sighting weapons or other devices emitting projectiles, and the like.

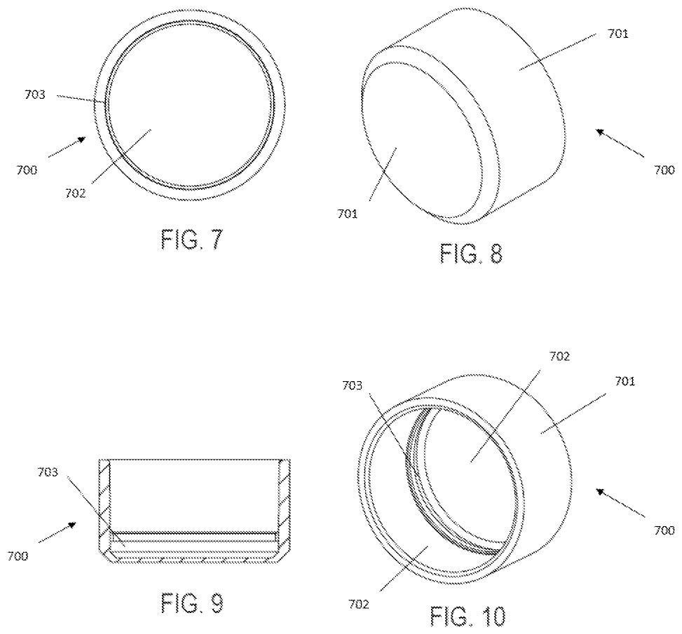

FIGS. 7-10 show several views of an example female mating joint component 700 configured to couple with a corresponding male joint component for a snap fit. FIG. 7 shows a top view of an example female mating joint component configured to couple with a corresponding male joint component for a snap fit. FIG. 8 shows an isometric view of exterior surfaces of an example female mating joint component configured to couple with a corresponding male joint component for a snap fit. FIG. 9 shows a sectional view of an example female mating joint component configured to couple with a corresponding male joint component for a snap fit. FIG. 10 shows an isometric view of interior surfaces of an example female mating joint component configured to couple with a corresponding male joint component for a snap fit.

Female mating joint component 700 may include exterior surfaces 701 and interior surfaces 702. Interior surfaces 702 may include ridges, notches, or grooves 703. Female mating joint component 700 may be configured, sized, and/or shaped to receive a corresponding male mating joint component. Ridges, notches, or grooves 703 may cooperate and/or engage with corresponding ridges, notches, or grooves on a male mating joint component to couple the joint components in a snap-fit configuration. Ridges, notches, or grooves 703 may be routed, milled, or otherwise manufactured into or onto female mating joint component 700. In an embodiment, female mating joint component 700 may be additively manufactured with any required ridges, notches, or grooves 703 (or any other required or desired feature) integrally formed.

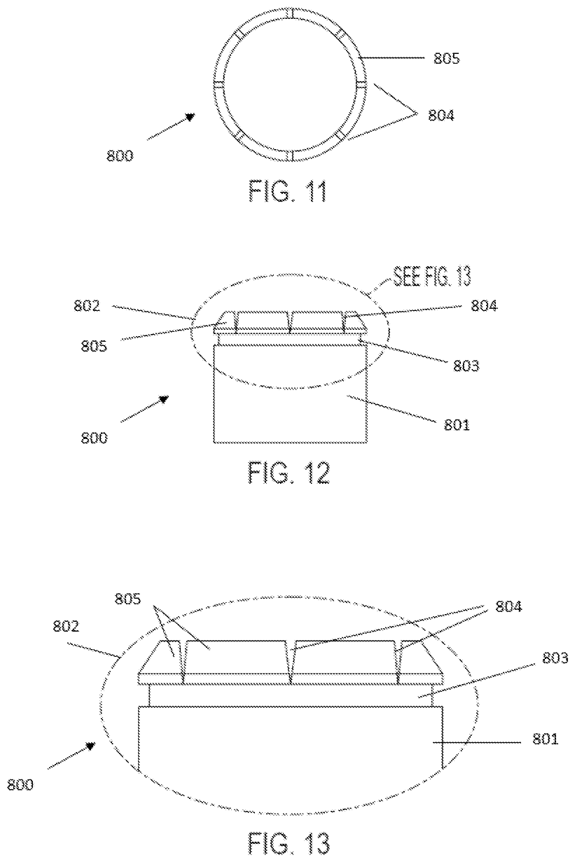

FIGS. 11-13 show several views of an example male mating joint component 800 configured to couple with a corresponding female joint component 700 for a snap fit. FIG. 11 shows a top view of an example male mating joint component. FIG. 12 shows a side perspective view of at least a portion of an example male mating joint component 800 disposed vertically. FIG. 13 shows an enlarged portion of the side perspective view of the example male mating joint component configured to couple with a corresponding female joint component for a snap fit depicted in FIG. 12. Male mating joint component 800 may include exterior surfaces 801. Male mating joint component 800 may also include ridges, notches, or grooves 803 configured to engage with corresponding ridges, notches, or grooves 703 on a female mating joint component.

Male mating joint component 800 may be at least partially inserted into a corresponding female mating joint component 700 until ridges, notches, or grooves 803 engage with corresponding ridges, notches, or grooves 703. A forward end 802 of male mating joint component 800 may correspond with the portion of male mating joint component 800 first inserted into a female mating joint component. Forward end 802 may include one or more notches 804 and one or more tapered edges 805. Notches 804 and/or tapered edges 805 may allow a user to more easily insert male mating joint component 800 into the corresponding female joint component.

In an embodiment, one or more portions of a male mating joint component and/or one or more portions of a female mating joint component may be scuffed, knurled, or otherwise made rough. A rough finish may enable a material from which a mannequin part is made more easily adhere to the joint component. For example, a portion of each of a male mating joint component and a female mating joint component may be manufactured to have a rough surface where the joint component is to engage with and adhere to (or be disposed in) a mannequin part. As an example, when joint components are made from ABS and mannequin parts are made from polyurethane, roughing a portion of the joint components may allow polyurethane to more securely adhere to the joint components.

Moreover, a person of ordinary skill in the art may recognize that by fitting together various mannequin components using articulated joints as described herein, individual mannequin components may be purchased separately and replaced. For example, if a mannequin is being used as a tactical mannequin and sustains a large amount of fire in one place, such as a left arm, eventually the heavily impacted arm may fail or be essentially destroyed. If the rest of the mannequin remains viable, a new left arm could simply be swapped out, reducing expenditures with purchasing another entire mannequin.

While various aspects and embodiments have been disclosed herein, other aspects and embodiments will be apparent to those skilled in the art. the various aspects and embodiments disclosed herein are for purposes of illustration and are not intended to be limiting, with the true scope and spirit being indicated by the following claims.

What is claimed is:

1. A joint system, comprising:
a first component having an external surface; and
a hollow second component having an internal surface;
wherein the first component and the second component are configured to couple with each other such that, when the first component and the second component are coupled, at least a portion of the external surface of the first component maintains contact with at least a portion of the internal surface of the second component; and
wherein the first component is configured to be disposed in a first mannequin part and the second component is configured to be disposed in a second mannequin part.

2. The joint system of claim 1, wherein the first component and the second component are configured to couple by an interference fit.

3. The joint system of claim 1, wherein the first component and the second component are configured to couple by a snap fit.

4. The joint system of claim 1, wherein the first component and the second component are configured to couple by a threaded coupling.

5. The joint system of claim 1, wherein the first component and the second component are substantially cylindrical.

6. The joint system of claim 5, wherein the external surface of the first component and the internal surface of the second component include cooperating ridges.

7. The joint system of claim 1, wherein the first component has a first outer diameter and a second outer diameter, the first outer diameter being larger than the second outer diameter; and wherein the portion of the first component having the first outer diameter is disposed within the first mannequin part.

8. The joint system of claim 1, wherein the second component has a first outer diameter and a second outer diameter, the first outer diameter being larger than the second outer diameter; and wherein the portion of the second component having the first outer diameter is disposed within the second mannequin part.

9. The joint system of claim 1, wherein the first component and the second component are formed from acrylonitrile butadiene styrene.

10. A figure shaped as a human or portion of a human, comprising:
a first hollow shell sized and shaped like a first human part, the hollow shell comprising a thermosetting polymer;
a second hollow shell sized and shaped like a second human part, the hollow shell comprising a thermosetting polymer;
a first joint component having an external surface and being disposed in the first hollow shell; and
a hollow second joint component having an internal surface and disposed in the second hollow shell;
wherein the first joint component and the second joint component are sized to couple with each other by one of (a) an interference fit such that, when the first joint component and the second joint component are coupled, at least a portion of the external surface of the first joint component maintains contact with at least a portion of the internal surface of the second joint component, or (b) a snap fit such that, when the first joint component and the second joint component are coupled, a ridge, notch, or groove on the first joint component engages with a corresponding ridge, notch, or groove on the second joint component.

11. The figure of claim 10, wherein, when the first joint component and the second joint component are coupled, the first hollow shell and the second hollow shell are coupled at a position corresponding to a human joint.

12. The figure of claim 10, wherein the first hollow shell is positionable in a plurality of positions with respect to the second hollow shell.

13. The figure of claim 10, wherein the first joint component and the second joint component comprise acrylonitrile butadiene styrene.

14. The figure of claim 10, wherein the first hollow shell and the second hollow shell comprise one or more polyurethanes.

15. The figure of claim 10, wherein the first joint component and the second joint component are substantially cylindrical.

16. The figure of claim 10, wherein the first joint component has a first outer diameter and a second outer diameter, the first outer diameter being larger than the second outer diameter; wherein the portion of the first joint component having the first outer diameter is disposed within the first hollow shell; wherein the second joint component has a first outer diameter and a second outer diameter, the first outer diameter being larger than the second outer diameter; and wherein the portion of the second joint component having the first outer diameter is disposed within the second hollow shell.

17. The figure of claim 10, wherein the external surface of the first joint component and the internal surface of the second joint component each have a plurality of ridges and grooves disposed thereon.

18. The figure of claim 10, wherein each of the first hollow shell and the second hollow shell have an average thickness of between about ⅕″ to about ½″.

19. The figure of claim 10, wherein one or more of the first hollow shell, the second hollow shell, the first joint component, or the second joint component is able to withstand the impact one or more of live ammunition and non-lethal ammunition without macro-scale damage.

20. The figure of claim 13, wherein the first joint component and the second joint component, when coupled, are capable of withstanding the impact of live ammunition without compromising the integrity of the coupled joint.

21. The figure of claim 20, wherein the first joint component and the second joint component, when coupled, are capable of withstanding the impact of a drop from a height of approximately five feet without comprising the integrity of the coupled joint.

22. A method of manufacturing a mannequin part, comprising:
calculating a total amount of a polyurethane by weight to be added to a mannequin mold;
disposing a substantially cylindrical and hollow acrylonitrile butadiene styrene joint component in the mannequin mold;
adding a first shot of between about 40% to about 50% of the calculated total amount of the polyurethane to the mold;
rotating the mold in a first rotating step at a temperature of between about 100 degrees Fahrenheit to about 120 degrees Fahrenheit;
adding a second shot comprising the reminder of the calculated total amount of polyurethane to the mold;
rotating the mold in a second rotating step at a temperature of between about 100 degrees Fahrenheit to about 120 degrees Fahrenheit; and
removing the molded polyurethane from the mold.

23. The method of claim 22, wherein the first rotating step continues for about five to about six minutes and wherein the second rotating step continues for about 30 to about 40 minutes.

24. The method of claim 22, wherein at least a portion of the acrylonitrile butadiene styrene joint component to be coated in a polyurethane has a rough exterior surface.
